(19) United States
(12) Patent Application Publication
(10) Pub. No.: US 2010/0017017 A1
(43) Pub. Date: Jan. 21, 2010

(54) Machine and Method for Self-Service Cash Redemption and Cash Recycling

(76) Inventors: Thomas P. Adams, Oconomowoc, WI (US); Robert E. Gunst, Neosho, WI (US)

Correspondence Address: QUARLES & BRADY LLP, 411 E. WISCONSIN AVENUE, SUITE 2040, MILWAUKEE, WI, 53202-4497, US

(21) Appl. No.: 11/991,685

(22) PCT Filed: Sep. 14, 2006
(86) PCT No.: PCT/US06/35859

§ 371 Date: Jul. 14, 2009

Related U.S. Application Data
(60) Provisional application No. 60/717,452, filed on Sep. 15, 2005.

(51) Int. Cl. G06F 7/00; G06M 3/00; G07F 9/08; G06Q 30/00; G06F 7/08

(52) U.S. Cl. 700/223; 194/215; 705/30; 235/381

(57) ABSTRACT

A cash redemption and dispensing machine (10) has a housing (12), a first intake area (19) for receiving a batch of unsorted coins, an output device (55) for providing the customer with a credit for the coins deposited in the machine (10), a dispensing area formed on a back side of the housing (10) for receiving a portable receptacle (22) into which the coins are dispensed in a sorted condition, a coin processing mechanism (21, 30, 29, 46, 50) for processing the coins that are deposited into the machine through the first intake area so that the coins can be dispensed by denomination through the dispensing area in the back side of the machine, and a controller (53) electronically connected to the coin processing mechanism (21, 30, 29, 46, 50) for calculating a first total for an amount of coins received through the first intake area, the controller (53) also being electrically connected to the coin processing mechanism (21, 30, 29, 46, 50) to track a second total for the coins being dispensed to the employee. A method of recycling coins is also disclosed.

### CROSS REFERENCE TO RELATED APPLICATIONS

This application claims the benefit of U.S. Provisional Appl. No. 60/717,452, filed Sep. 15, 2005 and is a continuation-in-part of U.S. patent application Ser. No. 10/821,004, filed Apr. 6, 2004 and a continuation-in-part of U.S. patent application Ser. No. 11/005,251 filed Dec. 6, 2004.

### TECHNICAL FIELD

The present invention relates to self-service cash redemption machines and methods in which a substantial batch of unsorted coinage is fed into the machine and is processed for collection while providing the user with a voucher or a form of credit, on a card, for example.

### BACKGROUND ART

The invention relates to a system and to a method in which a substantial number of unsorted coins (greater than the amounts spent in vending machines for purchasing items) are deposited in the machine. The coins are sorted and counted to determine a total value. The user is issued a receipt for the total value or a percentage of the total value. An example of such a machine is disclosed in U.S. patent application Ser. No. 11/005,251 filed Dec. 6, 2004 and published as US2006/0144670, on Jul. 6, 2006, and assigned to the assignee of the present invention.

This type of machine offers a service to the consumer and may provide a commission to the sponsoring organization. Since the introduction of state and local sales taxes, goods have been priced in such a way that people tend to accumulate a great deal of coinage. People tend to store this coinage in their homes. There have been few receivers of large amounts of coin change from consumers, other than banks, and people do not prefer to carry significant amounts of change in their pockets or purses. In recent years, certain voucher dispensing machines have been seen in grocery stores, which provide a voucher to the consumer for buying groceries or other items at the store or for redemption for cash. Some amount of the transaction is retained as a commission, usually less than 10%. Examples of machines for carrying out these transactions are shown and described in U.S. Pat. Nos. 6,736,251, 6,494,776, 6,484,863 and earlier related patents cited therein.

There is a need in retail businesses to dispose of collected coinage as well as to supply sorted coinage to cashiers for use at customer checkout stations. Many businesses now use armored vehicles to ship out bulk coinage and to receive packaged coinage for input to cash register terminals. This service adds overhead costs to a retail operation. It is also be possible to sort out change in back room operation, but this would also require additional labor and equipment.

In a patent application of the assignee herein, U.S. patent application Ser. No. 11/005,251 filed Dec. 6, 2004 and published as US2004/0231956 on Jul. 6, 2006, a bulk coin recycling apparatus and method has been proposed to sorting and counting a batch of unsorted coinage and then dispensing it into a cash drawer, for example.

This type of machine is most suited for employees of a business who would utilize the equipment in an area not accessible by customers.

The present invention seeks to utilize advantages of both types of machines in a totally new machine and method for use in banking and retail businesses. In this regard, the use of the term “banking” herein should be understood to broadly include financial businesses, such as banks, savings and/or lending businesses, credit unions and even government post offices.

### SUMMARY OF THE INVENTION

The invention relates to a method and a machine for receiving a batch of unsorted coinage from a banking or retail customer, and for dispensing a receipt or a form of credit to the banking or retail customer, and in which the coins are stored in bulk coin storage receptacles to be recycled to employees of the business for use at cashier or checkout locations.

The invention further provides an input for employees to deposit cash in the machine when desired. A cash intake slot and a cash dispensing slot are both located opposite a front side of the machine facing the banking or retail customer, and may be further located behind a partition separating the front side from a back side of the machine.

The invention is incorporated in a coin redemption and dispensing machine for receiving coins from a retail or banking customer and providing a receipt or credit to the retail or banking customer, and for dispensing the coins in a sorted condition into one or more portable receptacles for employees of the retail or banking business.

The machine comprises a housing, a first intake area on a front side of the housing for receiving batches of unsorted coins which are loaded into the machine by a retail or banking customer, an output device for providing the customer with a credit for at least a percentage of the unsorted coins deposited in the machine, a dispensing area formed in a back side of the housing for receiving one more portable receptacles into which the coins are dispensed in a sorted condition, a coin processing mechanism for processing the coins that are deposited into the machine through the first intake area so that the coins can be dispensed by denomination through the dispensing area in the back side of the machine, and a controller electronically connected to the coin processing mechanism for calculating a first total for an amount of coins received through the first intake area, the controller also being electrically connected to the coin processing mechanism for tracking a second total for the coins being dispensed to an employee.

The invention also involves a method of receiving coins for credit from a customer and for dispensing coins to employees for use in cash operations, the method comprising: depositing an unsorted batch of coins having a plurality of denominations into a machine through a first intake area on a front side of the machine, processing the coins that are deposited into the machine so that the coins can be dispensed by denomination through a dispensing area in a back side of the machine, totaling an amount of coins received through the first intake area and initiating output of a credit or receipt for a banking or retail customer, and totaling amounts of coins dispensed through the dispensing area in a back side of the machine and associating the amounts with employees identified with such amounts.

Other objects and advantages of the invention will be apparent from the drawings which are incorporated herein by reference and which illustrate a preferred embodiment of the invention. Such embodiment is to be understood to be by way of the example and that other embodiments are also contemplated as may be defined by the claims which follow the detailed description herein.

### BRIEF DESCRIPTION OF THE DRAWINGS

FIG. 1 is a perspective view of an interior assembly of the machine of the present invention with parts of the housing and a partition shown in phantom;

FIG. 2 a front view in elevation of a front side of the machine of FIG. 1;

FIG. 3 is a frontal perspective view of a portion of the machine of FIG. 1;

FIG. 4 is a rear perspective view of the interior assembly of FIG. 1;

FIG. 5 is a block diagram of the electronic control portion of the machine of FIGS. 1-4; and

FIG. 6 is an alternative embodiment of the mechanism shown in FIGS. 1 and 4.

### DETAILED DESCRIPTION OF A PREFERRED EMBODIMENT

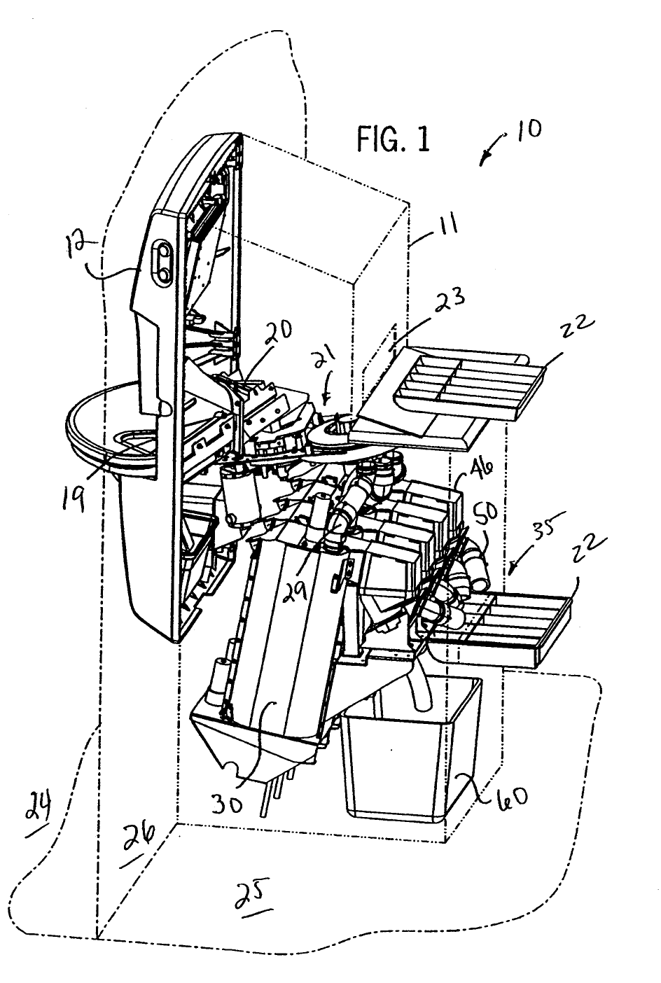

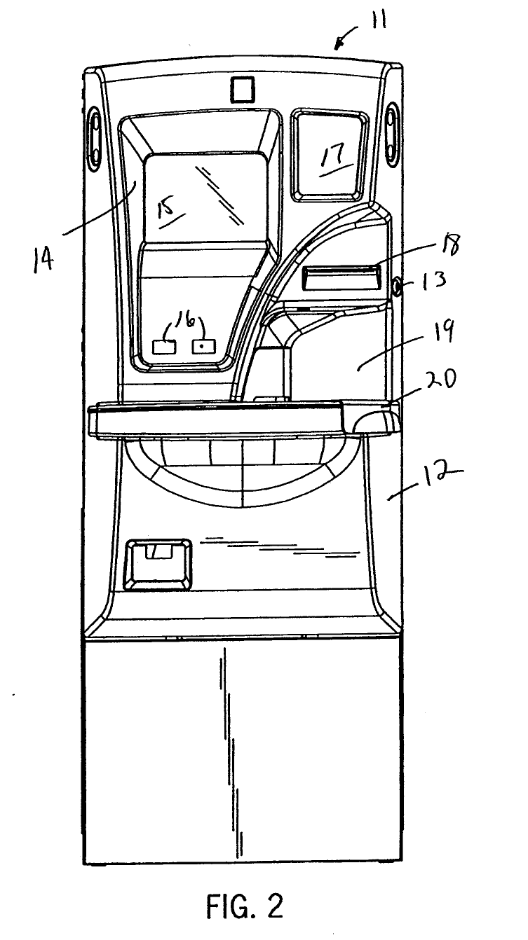

FIG. 1 shows a machine 10 in which a cabinet 11 has been shown in phantom to show the interior mechanisms. The front of the machine 10 is shown in FIG. 2. The machine 10 is housed in the cabinet enclosure 11 which has a front facade 12, provided predominantly by molded plastic parts, and assembled as part of a door assembly on a front side of the machine 10. The door assembly is secured in a closed position by a lock 13 (FIG. 2). The facade 12 has an opening 14 for viewing a screen 15 of a visual display. Below this screen 15 are two buttons 16, for allowing the user to enter selections of items on the screen 15. In addition a card reader/writer can be installed to read an identification card from a customer and credit amounts to a card. To the right of the display is an area for an advertising display 17 and below that is a printer output slot 18 for receiving a receipt, voucher or other printable matter that exits a printer installed inside the enclosure 11. Just below the printer output slot 18 is a cash redemption intake area 19 with an intake mechanism 20, which can be a tray that can be lifted to allow coins to slide into the machine 10 or a feeding mechanism as described and illustrated in U.S. Pat. Pub. No. US2006/0144670, published Jul. 6, 2006.

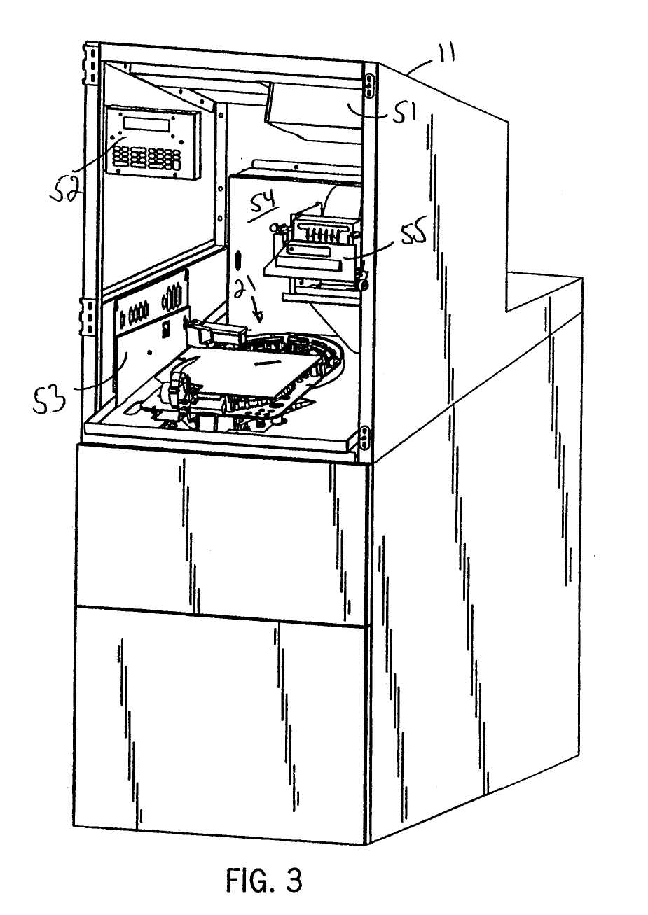

Referring to FIG. 3, with the upper part of the facade 12 removed, the interior mechanisms include a printer 55 operates under the control of a personal computer (PC) 51. Also seen in an interior of the cabinet 11 is a service keyboard 52, a controller 53 and a power supply 54. The controller 53 is also connected to the I/O devices such as the count sensors on a sorting mechanism 21 and other devices to be described herein. The printer 55 can print out a voucher or receipt representing the value and amount of coinage fed into the coin processing assembly 21 and counted by the controller 53 through sensing devices on the sorting mechanism 21. The user can present this voucher or receipt in payment for merchandise, or could, where permitted, redeem it for cash in the form of notes and a small amount of change less than one dollar. An optional built-in card reading device either stand-alone or communicating through a network interface for automatically crediting a financial account at a central computer, can also be used either in place of, or in conjunction with, the printer 55.

Referring again to FIGS. 1 and 2, the coin intake mechanism 20 can receive a batch of unsorted coins of mixed denomination for feeding into a coin sorter 21 (FIG. 1). This batch of coins is greater in amount than the coins typically inserted into a vending machine, for example, to purchase a product. The batch of coins can be continuously inputted as the machine is operating, so that it can process anywhere from a few dollars to perhaps two hundred dollars in U.S. coinage.

With this machine 10, a substantial number of unsorted coins (greater than the amounts spent in vending machines for purchasing items) can be received, sorted and counted to determine a total value. The user is issued a voucher through the printer output slot 18 in FIG. 1 for an amount related to the total value.

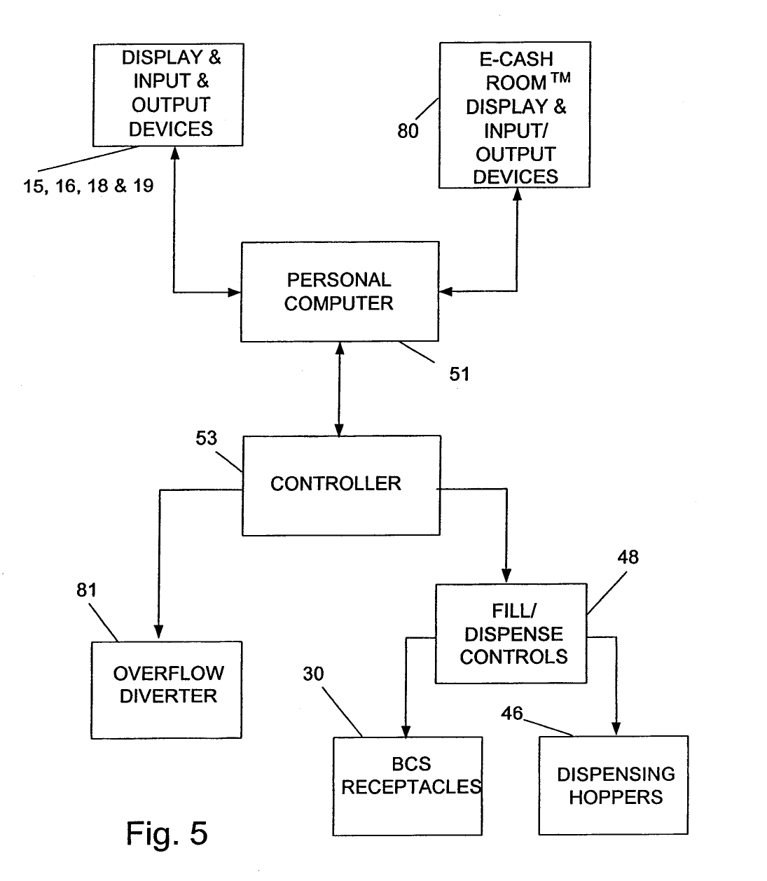

The machine 10 described and illustrated herein adds to such a self-service machine, by allowing the capability of recycling coins from customers (the public) in a banking or retail business to cash drawers of employees, such as the cash drawer 22 seen at a filling location 35 in FIG. 1. Please note that to the extent these are trays instead of drawers, that both are intended to be encompassed by the term “cash drawers,” as used herein. The machine 10 is installed in a customer service desk or other area of a banking or retail establishment, where the area 24 in front of the machine 10 is accessible by banking or retail customers, but an area 25 in the rear of the machine 10 is not accessible to customers, but only by employees or the business or service employees of third-party service organizations. A wall 26 or other barrier, represented in phantom in FIG. 1, is positioned in between these two areas 24, 25. The machine 10 has a coin recycling intake opening 23 at the rear for accepting batches of coins from cash drawers 22 of employees. During the employee coin inputting operation, the feeder mechanism at the customer side must be temporarily inactivated as there exists one common coin sorting and counting device. A dispensing area is also provided in the cabinet 11 at the filling location 35. A keypad/card reader input device and an optional touch screen input device can be mounted near the cash recycling intake opening 23. These are included in the input and output devices represented by block 80 in FIG. 5. The keypad/card reader or other input device would enable an identity of an employee to be associated with each batch of coins received or put into the machine 10 from the rear area 25.

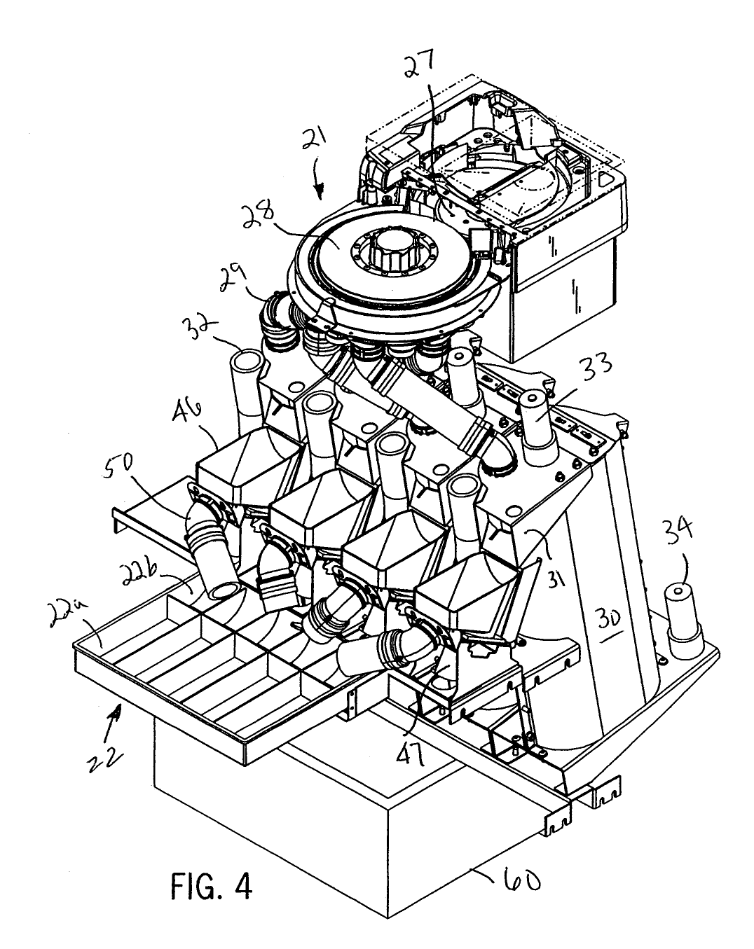

For dispensing coins, the machine 10 has dispensing hoppers 46 for counting amounts of coin of each denomination as the coins are dispensed through spouts 50 into a cash drawer 22. Coins that are received in the machine 10 are first directed to bulk coin storage (BCS) receptacles 30 which store coins by denomination for supplying the individual dispensing hoppers 46 with coinage as needed. Upon reaching the defined capacity of any or all of the BCS receptacles, subsequently inputted coins are electro-mechanically diverted (not shown) into an overflow bin 60 as shown in FIG. 1. This overflow bin 60 accepts all denominations through diverter chutes 32 seen in FIG. 4. It is intended that the overflow bin 60 be easily removed and transported to and from the machine. As seen in FIG. 4, the coin sorter 21 has a queuing disc 27 that is positioned inwardly and below of an opening from cash redemption intake area 19 and below cash recycling intake opening 23. The queuing disk 27 arranges coins in a single file to be transferred to a sorting plate by a coin driving disc 28 which is disposed over the sorting plate of the sorter 21.

The coins then are moved by driving disc 28 over a sorting plate, where the coins are sorted through sorting apertures of a type shown and described in Adams et al., U.S. Pat. Nos. 5,295,899 and 5,525,104. When the coins of respective denominations fall through the sorting apertures, they are conveyed in the present invention by tubular chutes 29 (FIG. 4) to mechanized bulk coin storage (BCS) receptacles 30 to be described below. There is one feed chute 29 and one BCS receptacle 30 for each of the US denominations of pennies, nickels, dimes and quarters. The first receptacle 30 holds pennies and while other receptacles 30 hold nickels, dimes and quarters, respectively.

Although the number of BCS receptacles 30 in the present embodiment is four, different numbers of BCS receptacles can be provided for additional denominations in the US coin set, such as halves or for doubling capacity for pennies for example. Different numbers of BCS receptacles could also be provided for the euro coin set, the Canadian coin set, or other coin sets used by other countries in the world.

As illustrated in FIG. 4, each of the tubular chutes 29 are fixed in position to feed into the BCS receptacles 30. A diverter mechanism represented by block 81 in FIG. 5 can be actuated to divert coins to nearly vertical chutes 32 that supply coins to the overflow bin 60. The diverter mechanism can be a stepper motor and linkage to move the or pivot the chutes 29 so as align their exit ends with the open entrances to the diverter chutes 32.

From the bulk coin storage receptacles 30, coins are transferred through exit chutes 31 having rectangular exit openings leading to the dispensing hoppers 46. The dispensing hoppers 46 have a smaller capacity for holding coins than the BCS receptacles 30. They are located immediately in front of their corresponding BCS receptacles 30 and receive coins through the exit chutes 31 (FIG. 4). Coins are received in the dispensing hoppers 46 in a pile rather than being stacked in columns. The dispensing hoppers 46 have coin ejection mechanisms that are operated by motors 47 (FIG. 4) to eject coins individually through the tubular exit spouts 50 to the cash drawer 22. The exit spouts 50 have elbows and straight portions, and can be rotated to adjust the position of the exit over the cash drawer 22. The cash drawer 22 in this example has four note compartments 22a and four coin compartments 22b. The coin dispensing hoppers 46 also have sensors for detecting each coin as it is dispensed. In this way, a controller can be signaled with signals indicating the number of coins dispensed from each of the dispensing hoppers 46.

Referring to FIGS. 1, the BCS receptacles 30 are bins that are oval-shaped in cross section. The BCS receptacles 30 are sized to hold piles of loose coins which are not stacked in columns. Coins flow into the BCS receptacles 30 from the top. The volume of each BCS receptacle 30 is substantially greater than, approximately ten times greater than, the volume of the corresponding coin dispensing hopper 46. Each BCS receptacle 30 is many times wider than an individual coin stored therein.

Each BCS receptacle 30 has a limit switch near the top of the receptacle to sense the coin level in the receptacle, and it also has a limit switch at the bottom of the receptacle to sense a piston at its lowest position. The piston is moved by a belt and motor 34. At the top of the receptacle 30, a skimmer mechanism powered by a motor 33 pushes coins through exit chute 31. Further details of the BCS receptacles 30 are described in U.S. Pat. Pub. No. US2004/0231956, published Nov. 25, 2004, the disclosure of which is hereby incorporated by reference for describing the operation of a coin processing mechanism for recycling coins from an input of unsorted coins to an output of sorted coins, while tracking inputs and output totals.

In the present application, only four dispensing hoppers 46 have been shown for pennies, nickels, dimes and quarters, respectively, but for the euro coin set as many as eight dispensing receptacles could be used for denominations of one euro cent through two euros. It is also possible to deposit or dispense a single denomination of coins with the machine.

The machine 10 in this embodiment is provided with an initial amount of coins before beginning dispensing operations. It would then be available for dispensing operations, as well as coin intake operations in which tills or cash drawers are emptied in the intake opening 23. The dispensing of coins to an employee can be carried on simultaneously with the customer self-service cash redemption operations at the front of the machine 10.

The coin exit sensors on the coin sorter 21 allow the controller to track the amount of coinage deposited into the machine 10. The count sensors on the dispensing hoppers 46 allow the controller to track the amount of each denomination that is dispensed. By subtracting the second number from the first number for each denomination, the amount of coins in the machine 10 for each denomination can be determined. In addition, the amounts received and dispensed from individual employees can be tracked and reconciled.

The coin recycling operations of the machine 10 are directed by a controller 53 seen in FIGS. 3 and 5. The controller 53 includes a power supply, a main processor control board and a group of I/O (input/output) interface boards. The main processor control board includes a microelectronic CPU for executing a suitable control program, a memory for non-volatile storage of the control program and a RAM memory for temporary storage of data during operation. The main processor board is directly connected to sensors at the sorting exits of the sorter 21 to sense and count denominations sorted by the sorter 21. The main processor board is also connected to a coin present sensor, which is utilized to start and stop the coin sorter.

The controller 53 will control the coin sorter 21, control the dispensing of coins from hopper assemblies 46, control the keypad/card reader or the touch screen (human interface). Such a controller 53 can also be used to maintain database information related to completed transactions, malfunctions and system errors, machine usage, and other data. The controller 53 receives commands from a personal computer 51, and communicates with the display and input/output devices 15, 16, 18 and 19 for the cash redemption portion of the machine, as well as with the display and input and output devices 80 for the cash recycling portion of the machine (known as E-Cash Room™), including a keypad/card reader and touch screen.

The main processor board in the controller 53 is connected through the I/O (input/output) interface boards to fill/dispense controls 48 as shown in FIG. 5. The I/O interface boards each include a logic circuit or I/O control CPU for closing a control loop through certain of the sensors on the I/O interface boards as will be explained further below. Signals and data for other sensors are communicated back and forth the main controller CPU as will be explained below. Sensors such as an upper limit switch and lower limit switch for sensing the limits of travel of the piston would be sensed and controlled by the I/O control logic circuit or CPU. The I/O interface boards would each be connected to a level sensor disposed approximately at the level where coins are skimmed off into the dispensing receptacles 46. The I/O interface boards would be connected to drive the BCS motors 34 in either rotational direction to raise and lower a piston in the BCS receptacles 30. They would also sense the level of coins in the dispensing hoppers 46 through a dispensing hopper coin level sensor in each hopper. The hopper motor for ejecting coins from each of the dispensing hoppers 46 would be interfaced through the I/O interface board, but controlled by the main controller CPU. So, too, the dispensing hopper count sensor for detecting and counting coins as they exit each hopper 46 would be connected through the I/O interface board to send count signals or at least count totals back to the main controller 53.

The replenishment of the dispensing hoppers 46 takes priority over the filling of the BCS receptacles 30. It is assumed here that there is an additional start-up sequence to place an initial amount of coins first in the BCS receptacles. On start-up, the machine 10 will require a starting balance of coin to satisfy initial dispensing commands. Bulk coin is fed into the sorter 21. It is then sorted into the BCS receptacles 30 and an initial amount is transferred to the dispensing hoppers 46. The machine controller 53 stores the value of the coinage denominations which have been input into the machine 10.

When an employee/cashier reports for work, he or she needs to fill his or her cash drawer 22 or till to start the day. Commands, such as “deposit” and “dispense” are input to the controller 80. The controller 80 is able to execute the commands in overlapping fashion using a multi-tasking type of operation.

If a drawer fill command is received, then coin is dispensed into compartments 22b in the cash drawer or till 22. From the employees sign-on identity a known quantity of pennies, dimes, nickels, quarters will be assigned to that employee. In this operation, the hopper motors 47 are started, and the prescribed quantities of individual denominations are dispensed from the coin hoppers 46 into the cash drawer simultaneously. The coins are detected as they exit the hoppers, and the hopper motors 47 are stopped when the dispensing is complete.

If, during the work shift, an employee needs more coinage, the employee can sign on the machine 10 and request more coinage of all or of individual denominations. The coinage is then charged to the employee's account.

At the end of the employee's shift, the employee will sign on and initiates a “BALANCE” or “RECONCILE” operation. When the employee returns coinage during a work shift, the coinage is deposited in the cash recycling intake area 23, the employee inputs an ID or account number through a card reader or keypad represented by block 80, and the machine 10 is started to sort the coins and store them in the bulk coin storage receptacles 30. Otherwise, the machine is in a wait loop. The sorter 21 then sorts the coins and stores coins of respective denominations in the respective BCS receptacles 30. The amount deposited is counted by sensors on the coin sorter 21 as the coins are sorted. A test is executed to see when all the coins have been sorted, and when the result is yes, the sorter motor is stopped. The amount totals are accumulated and will be added to the amounts already stored in the bulk coin storage receptacles 30. The deposited amounts are stored in the controller memory along with the user account number. All of this information can also be sent as data to an external device.

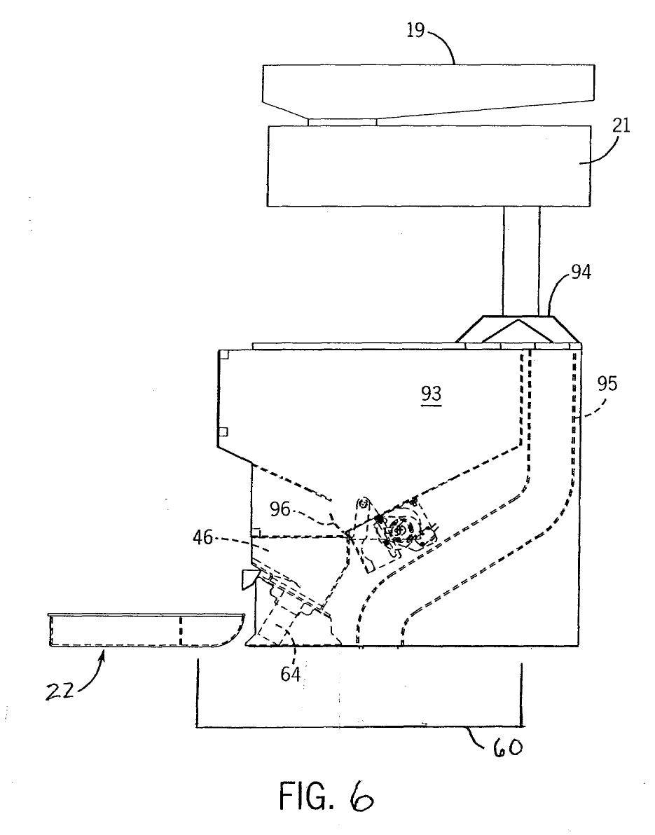

FIG. 6 shows a modification to the BCS receptacles for the present invention. The machine includes the intake hopper 19, the coin sorter 21 and the other parts of the coin recycling machine 10 described previously. Instead of the BCS receptacles 30 with lifting platforms, this modification provides large gravity feed hoppers 93 for bulk storage of coin. A diverter 94 is used to direct coins either to a diverter tube 95 or to the gravity feed hopper 93. The hopper 93 has an exit control mechanism 96 to control the dispensing of coins downward into the dispensing hoppers 46. The gravity feed hoppers 93 (four for this example) each have a volumetric capacity of approximately ten times that of the dispensing hoppers 46, but do not have a capacity as great as the mechanized BCS receptacles 30 which utilize the motorized lifting platform to transfer coins to the dispensing hoppers 46.

The coin recycling machine 10 can also be connected to a note recycler 11 and can send dispense commands to dispense notes and receive data representing amounts of notes deposited in the note recycler 11. This allows the tracking of both coins and notes for various employees. The controller 53 of the present invention can also be provided in a note recycler for tracking notes dispensed to an employee and notes received from an employee, using a card reader and note denomination receptacles as described for the coin recycling machine.

Thus, a machine 10 for performing both self-service cash deposit for a voucher and cash recycling by employees of a financial or retail establishment is disclosed. In this way, cash is provided for retail operations without having to purchase packaged cash. This provides a savings for businesses as well convenience for both customers and employees, while also providing the necessary security for cash handling operations.

This has been a description of a preferred embodiment and various details concerning a preferred embodiment. The invention is intended to cover not only this detailed embodiment, but also other embodiments that may contain modifications apparent to one of ordinary skill in the art, but nevertheless come within the scope of the following claims.

We claim:

1. A coin redemption and dispensing machine for receiving coins from a retail or banking customer and providing a receipt or credit for the retail or banking customer, and for dispensing the coins in a sorted condition into a portable receptacle for an employee of the retail or banking business, the machine comprising:
a housing;
a first intake area on a front side of the housing for receiving a batch of unsorted coins which are deposited into the machine by the customer;
an output device for providing the customer with a credit for at least a percentage of the unsorted coins deposited in the machine;
a dispensing area formed in a back side of the housing for receiving a portable receptacle into which the coins are dispensed in a sorted condition;
a coin processing mechanism for processing the coins that are deposited into the machine through the first intake area so that the coins can be dispensed by denomination through the dispensing area in the back side of the machine; and
a controller electronically connected to the coin processing mechanism for calculating a first total for an amount of coins received through the first intake area, the controller also being electrically connected to the coin processing mechanism to track a second total for the coins being dispensed to the employee.

2. The redemption and dispensing machine of claim 1, wherein the portable receptacle is a cash drawer and wherein the housing has a second intake area on a back side of the machine for accepting deposit of coins from a receptacle being handled by an employee.

3. The redemption and dispensing machine of claim 2, the second intake area is a cash drawer receiving area adapted to receive a cash drawer having multiple compartments; and
wherein the coins are dispensed through the dispensing area into the multiple compartments of the cash drawer by denomination.

4. The coin redemption and dispensing machine of claim 1, wherein there is a partition separating a front side of the housing from a back side of the housing so that the back of the housing cannot be accessed or viewed by a retail or banking customer.

5. The coin redemption and dispensing machine of claim 1, wherein said controller is able to total the coins being loaded into the machine in an input operation as well as total coins being dispensed in an output operation during a time interval in which the input operation is also being conducted.

6. The coin redemption and dispensing machine of claim 1, wherein the an output device for providing the customer with a credit is a printer.

7. The coin redemption and dispensing machine of claim 1, wherein the output device for providing the customer with a credit is a card reader/writer.

8. The coin redemption and dispensing machine of claim 7, wherein there is an input device disposed on a back side of the machine to allow employees to enter an identification to be associated with amounts of coins being dispensed through the dispensing area.

9. The coin redemption and dispensing machine of claim 1, wherein the an output device for providing the customer with a credit is a network interface for communicating with a central computer.

10. The coin redemption and dispensing machine of claim 1, wherein the controller includes a memory for storing a plurality of employee accounts with a balance per employee of coins received and coins dispensed.

11. The coin redemption and dispensing machine of claim 1, further comprising:
an input device electrically connected to the controller for transferring inputs from a plurality of employees to the controller; and
wherein the controller associates inputs from a plurality of employees with cash balances of coins dispensed and received for respective users.

12. The coin redemption and dispensing machine of claim 1, further comprising:
a personal computer electrically connected to the controller for transferring inputs from a plurality of employees to the controller; and
wherein the personal computer associates inputs from a plurality of users with cash balances of coins dispensed and received for respective employees.

13. A method of receiving coins from a customer for credit and for dispensing coins to an employee for use in cash operations, the method comprising:
the customer depositing a batch of coins having a plurality of denominations into a machine through a first intake area on a front side of the machine;
processing the coins that are deposited into the machine so that the coins can be dispensed to an employee by denomination through a dispensing area in a back side of the machine;
totaling amounts of coins received through the first intake area and initiating output of a credit for the deposit by the customer; and
tracking an amount of coins dispensed through the dispensing area in a back side of the machine and associating the amounts with an employee identified with such an amount.

14. The method of claim 13, further comprising depositing batches of coins from cash drawers through a second intake area on a back side of the machine.

15. The method of claim 13, further comprising crediting employees with amounts of coins deposited through a second intake area on the back side of the machine.

16. The method of claim 13, further comprising storing a plurality of user accounts with a balance per user of cash received and cash dispensed.

17. The method of claim 13, further comprising:
reading in identification inputs from a plurality of employees; and
associating said identification inputs from a plurality of employees with cash balances of cash dispensed and received for respective employees.

18. The method of claim 17, wherein the identification inputs from the employees are read in on a back side of the machine, and further comprising reading in identification inputs from the customer from a location on a front side of the machine to enable a credit to the customer for the deposit.

19. The method of claim 18, wherein the back side of the machine is shielded from view by customers accessing the front side of the machine.

20. The coin redemption and dispensing machine of claim 13, wherein the coins being deposited into the machine by a customer can be totaled while coins are being dispensed to an employee.
